(19) United States
(12) Patent Application Publication
(10) Pub. No.: US 2013/0149026 A1
(43) Pub. Date: Jun. 13, 2013

(54) ATTACHMENT MECHANISM FOR ELECTRONIC COMPONENT

(71) Applicant: LI-REN FU, Shenzhen City (CN)

(72) Inventor: LI-REN FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/424,390

(22) Filed: Mar. 20, 2012

(30) Foreign Application Priority Data
Dec. 7, 2011 (CN) 201110402780.9

(51) Int. Cl. F16B 7/04

(52) U.S. Cl. 403/289

(57) ABSTRACT

An attachment mechanism for fixing an electronic component in place includes a circuit board and a fixing member. The circuit board includes a first connector to connect a second connector of the electronic component, and defines a hole. The fixing member includes a mounting portion defining a hooking slot through which a mounting tab extending from the electronic component extends, and an engaging foot. The engaging foot includes an extension portion extending down from a bottom of the mounting portion and two resilient blocks extending up from a lower portion of the extension portion. The resilient blocks is operable to be deformed to extend through the hole, and abuts against a bottom surface of the circuit board after passing the hole.

### BACKGROUND

1. Technical Field

The present disclosure relates to a mechanism for attaching an electronic component to a device.

2. Description of Related Art

An electronic component, such as an expansion card, in an electronic device, is attached to a motherboard. An end of the expansion card is connected to the motherboard by a connector, and an opposite end of the expansion card is fixed to the motherboard with screws. Mounting the expansion card to the motherboard with screws is inefficient and requires the use of a tool, such as a screwdriver, which is inconvenient.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an attachment mechanism, together with an electronic component, wherein the attachment mechanism includes a fixing member.

FIG. 2 is an inverted view of the electronic component of FIG. 1.

FIG. 3 is an inverted view of the fixing member of FIG. 1.

FIG. 4 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

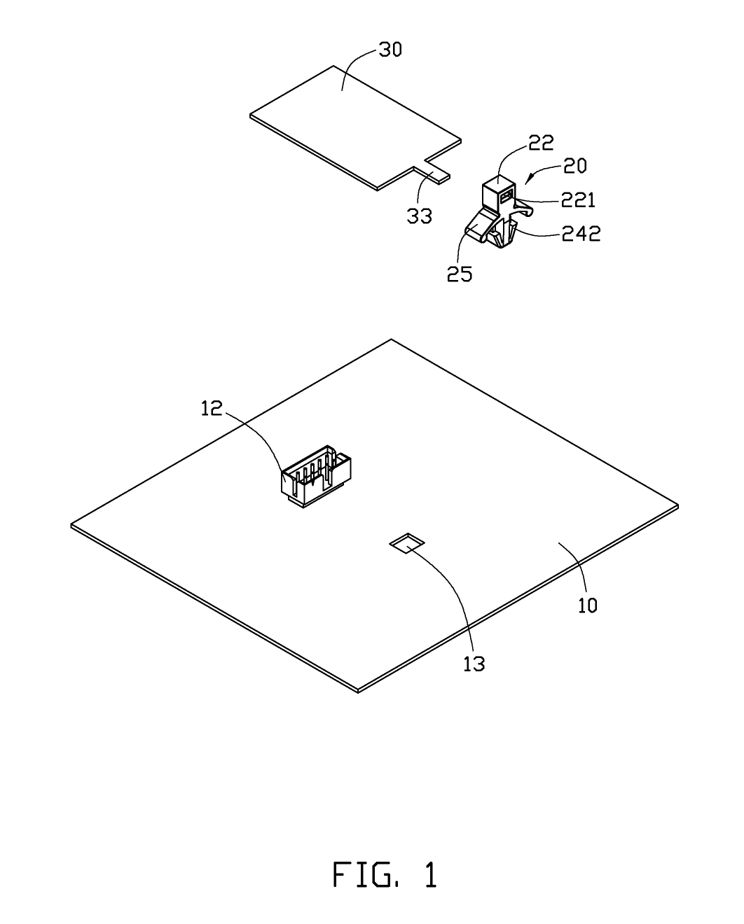

Referring to FIG. 1, an exemplary embodiment of an attachment mechanism for fixing an electronic component 30 in place includes a circuit board 10 and a fixing member 20.

A first connector 12 is fixed to the circuit board 10. A hole 13 is defined in the circuit board 10, beside the first connector 12.

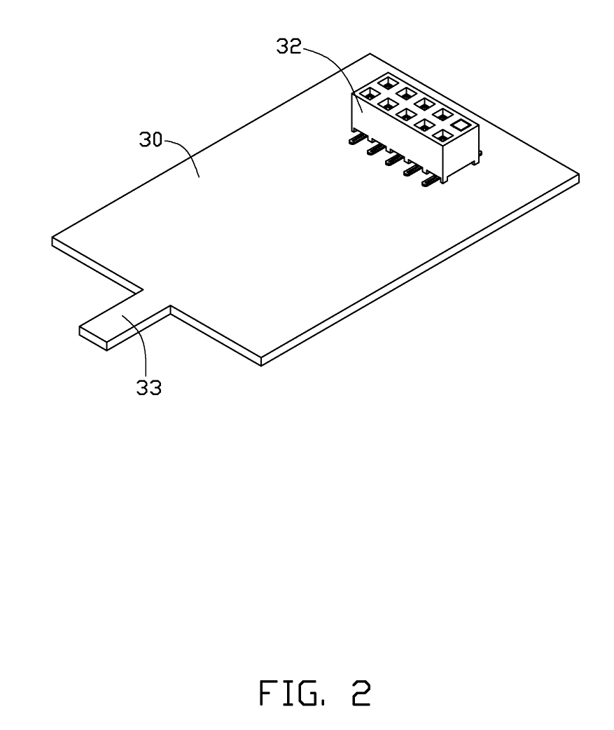

Referring to FIG. 2, a second connector 32 is fixed to a first end of a bottom surface of the electronic component 30. A mounting tab 33 extends from a second end of the electronic component 30 opposite to the first end, coplanar with the electronic component 30.

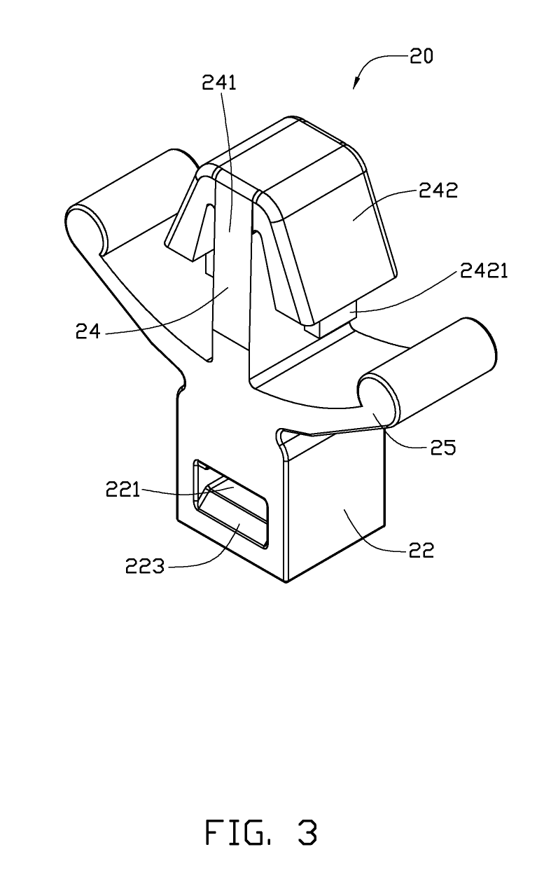

Referring to FIG. 3, the fixing member 20 includes a mounting portion 22, an engaging foot 24 extending down from a bottom of the mounting portion 22, and two abutting arms 25 slantingly extending down from opposite sides of an upper portion of the engaging foot 24. A through hooking slot 221 is defined in the mounting portion 22. Two slanting guiding surfaces 223 are formed on the mounting portion 22, one of which is connected to an end of a top wall bounding the hooking slot 221, and the other of which is connected to a same end of a bottom wall bounding the hooking slot 221. The engaging foot 24 includes an extension portion 241 perpendicularly extending down from the bottom of the mount portion 22, and two resilient blocks 242 slantingly extending up from opposite sides of a lower portion of the extension portion 241. An abutting block 2421 extends up from a top end of each resilient block 242.

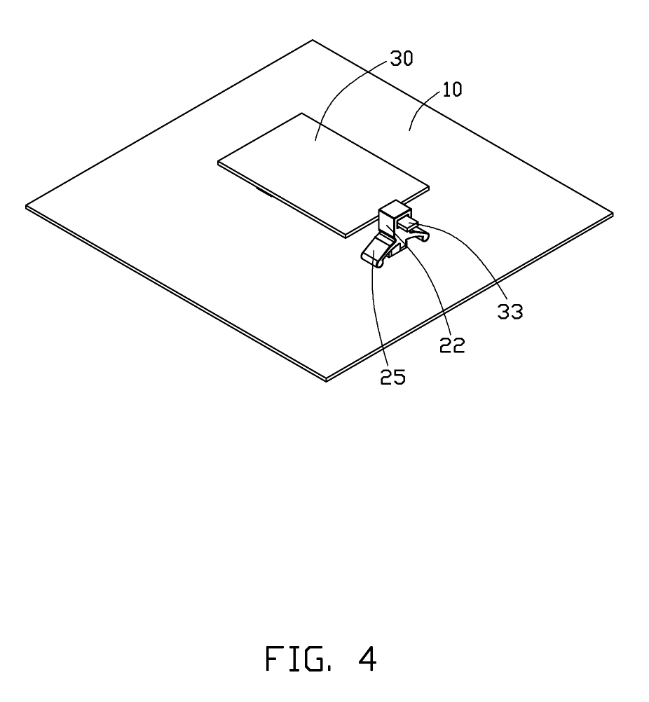

Referring to FIG. 4, in assembly, the resilient blocks 242 are manipulated toward each other and extended through the hole 13. When the abutting blocks 2421 pass through the hole 13, the resilient blocks 242 are self-restored. The abutting blocks 2421 abut against a bottom surface of the circuit board 10. The abutting arms 25 abut against a top surface of the circuit board 10. Therefore, the fixing member 20 is fixed to the circuit board 10.

To fix the electronic component 30 in place, the mounting tab 33 is manipulated to be guided by the guiding surfaces 223 to extend through the hooking slot 221. The second connector 32 is connected to the first connector 12. Therefore, the electronic component 30 is fixed to the attachment mechanism.

It is believed that the present embodiments and their advantages will be understood from the foregoing description, and various changes may be made thereto without departing from the spirit and scope of the description or sacrificing all of their materials advantages, the examples hereinbefore described merely being exemplary embodiments.

What is claimed is:

1. An attachment mechanism for fixing an electronic component in place, comprising:
a circuit board comprising a first connector to connect a second connector of the electronic component, and defining a hole; and
a fixing member comprising a mounting portion defining a hooking slot through which a mounting tab extending from an end of the electronic component extends, and an engaging foot comprising an extension portion extending down from a bottom of the mounting portion and two resilient blocks slantingly extending up from a lower portion of the extension portion, the resilient blocks operable to be deformed to extend through the hole, thereby the resilient blocks abutting against a bottom surface of the circuit board after passing the hole.

2. The attachment mechanism of claim 1, wherein the resilient blocks slantingly extend up from opposite sides of the lower portion of the extension portion.

3. The attachment mechanism of claim 2, wherein an abutting block extends up from a top end of each resilient block for abutting against the bottom surface of the circuit board.

4. The attachment mechanism of claim 1, wherein the fixing member further comprises two abutting arms slantingly extending down from opposite sides of the extension portion.

5. The attachment mechanism of claim 1, wherein two slanting guiding surfaces are respectively formed on corresponding ends of a top wall and a bottom wall bounding the hooking slot.
